(19) United States
(12) Patent Application Publication
(10) Pub. No.: US 2021/0312062 A1
(43) Pub. Date: Oct. 7, 2021

(54) RECORD MANAGEMENT APPARATUS

(71) Applicant: FUJIFILM Business Innovation Corp., Tokyo (JP)

(72) Inventor: Hironori TANAKA, Kanagawa (JP)

(73) Assignee: FUJIFILM Business Innovation Corp., Tokyo (JP)

(21) Appl. No.: 17/138,851

(22) Filed: Dec. 30, 2020

(30) Foreign Application Priority Data
Apr. 7, 2020 (JP) 2020-069123

(51) Int. Cl. G06F 21/60; H04L 9/08; G06F 16/22

(52) U.S. Cl. CPC G06F 21/602; G06F 16/22; H04L 9/0838

(57) ABSTRACT

A record management apparatus includes a processor configured to, about use of an apparatus by an authorized user other than a manager of the apparatus, acquire an execution record of a process performed by the apparatus and charge information about a charge for the process, encrypt the execution record by using a specific encryption key, store the charge information and the encrypted execution record in a storage, and in response to a request from the manager, provide to the manager a password that is temporarily valid to acquire a decryption key for decryption of the encrypted execution record.

### CROSS-REFERENCE TO RELATED APPLICATIONS

This application is based on and claims priority under 35 USC 119 from Japanese Patent Application No. 2020-069123 filed Apr. 7, 2020.

### BACKGROUND

### (i) Technical Field

The present disclosure relates to a record management apparatus.

### (ii) Related Art

In so-called share offices and rental offices, a printer or other apparatuses may be shared by users who are members of a plurality of organizations or persons other than those members. In this case, there is a demand to secure the confidentiality of information on the users of the apparatuses and information on processes.

Japanese Unexamined Patent Application Publication No. 2011-65364 discloses a technology in which a manufacturer or dealer of an apparatus may locate what kind of trouble the apparatus has in a way similar to the familiar one while protecting users' confidential information. In this technology, secret information contained in log data is replaced with renamed information, and the processed log data is registered in a job log database.

### SUMMARY

Aspects of non-limiting embodiments of the present disclosure relate to the following circumstances. In a case where an apparatus is shared by users who are members of a plurality of organizations or persons other than those members, a manager of the apparatus other than the users may manage the apparatus itself or usage costs of the apparatus. In this case, the manager of the apparatus may acquire confidential information of the users about the usage of the apparatus to manage the usage costs of the apparatus.

Aspects of non-limiting embodiments of the present disclosure therefore relate to a technology in which the manager of the apparatus may acquire the information about the usage of the apparatus shared by the plurality of users as necessary while keeping the confidentiality of this information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a record management apparatus comprising a processor configured to, about use of an apparatus by an authorized user other than a manager of the apparatus, acquire an execution record of a process performed by the apparatus and charge information about a charge for the process, encrypt the execution record by using a specific encryption key, store the charge information and the encrypted execution record in a storage, and in response to a request from the manager, provide to the manager a password that is temporarily valid to acquire a decryption key for decryption of the encrypted execution record.

### BRIEF DESCRIPTION OF THE DRAWINGS

An exemplary embodiment of the present disclosure will be described in detail based on the following figures, wherein:

FIG. 1 illustrates the overall configuration of a record management system according to an exemplary embodiment;

FIG. 2 illustrates the functional configuration of a log management server;

FIG. 3 illustrates an example of the hardware configuration of the log management server;

FIG. 4 illustrates an example of the hardware configuration of an image processing apparatus that is an example of a management target apparatus;

FIG. 5 illustrates the functional configuration of a controller of the image processing apparatus;

FIG. 6 is a flowchart illustrating operations to be performed when the log management server acquires a job log;

FIG. 7 is a flowchart illustrating operations to be performed by the log management server when a manager refers to an execution log;

FIG. 8 illustrates an example of the structure of the job log;

FIG. 9 illustrates an example of the structure of charge information; and

FIGS. 10A and 10B illustrate examples of the structures of execution logs.

### DETAILED DESCRIPTION

An exemplary embodiment of the present disclosure is described below in detail with reference to the accompanying drawings.

<Overall Configuration>

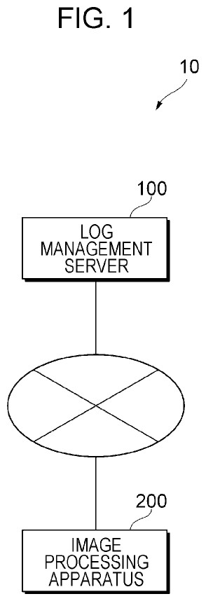

FIG. 1 illustrates the overall configuration of a record management system according to this exemplary embodiment. A record management system 10 of this exemplary embodiment includes a log management server 100 and an image processing apparatus 200 that is an example of an apparatus whose records are managed. The log management server 100 and the image processing apparatus 200 are connected via a network.

The log management server 100 is provided on the network, and acquires and manages record information (log) from the image processing apparatus 200. Although FIG. 1 illustrates a single server, functions of the log management server 100 may be distributed among a plurality of servers. The log management server 100 may be a virtual server implemented by using resources on the network.

The image processing apparatus 200 is a management target apparatus whose record information is managed by the log management server 100. The image processing apparatus 200 executes a process in response to a processing request and generates record information along with the execution of the process. The image processing apparatus 200 is connected to the log management server 100 via the network and transmits the generated record information. The image processing apparatus 200 generates two types of record information along with the execution of the process. The first record information is about a record of the executed process. This record information is hereinafter referred to as “execution log”. The second record information is about a charge for the execution of the process. This record information is hereinafter referred to as “charge information”. The execution log and the charge information are collectively referred to as “job log”.

In this exemplary embodiment, the image processing apparatus 200 that is the management target apparatus is shared by users who are members of a plurality of organizations or persons other than those members. Usage costs of the image processing apparatus 200 are managed by a manager of the image processing apparatus 200. Examples of the manager include an owner of the image processing apparatus 200, a person who provides a service to use the image processing apparatus 200, and an operator of an organization that provides the service. Examples of the users include members of organizations and other individuals (not belonging to organizations) authorized to use the image processing apparatus 200 by contracts. The user is charged for the use of the image processing apparatus 200 and the charge is managed by the manager. In this exemplary embodiment, the user who wants to use the image processing apparatus 200 is required to log in to identify the user for charging.

The organizations and the individuals (not belonging to organizations) authorized to use the image processing apparatus 200 by contracts are hereinafter referred to as “contractors”. Therefore, the users of the image processing apparatus 200 are categorized into members of organizations corresponding to the contractors (i.e., the contractors are organizations) and the contractors themselves (i.e., the contractors are individuals). The management target apparatus is not limited to the image processing apparatus 200 in the drawings as long as the execution of the process is charged and record information is generated about the process and the charge. However, this exemplary embodiment is described based on the example in which the management target apparatus is the image processing apparatus 200.

The specific configuration of the network is not particularly limited as long as the log management server 100 and the image processing apparatus 200 may exchange data via the network. Examples of the network include a local area network (LAN), a wide area network (WAN), and the Internet. Network communication may be made by wire or wireless.

<Functional Configuration of Log Management Server>

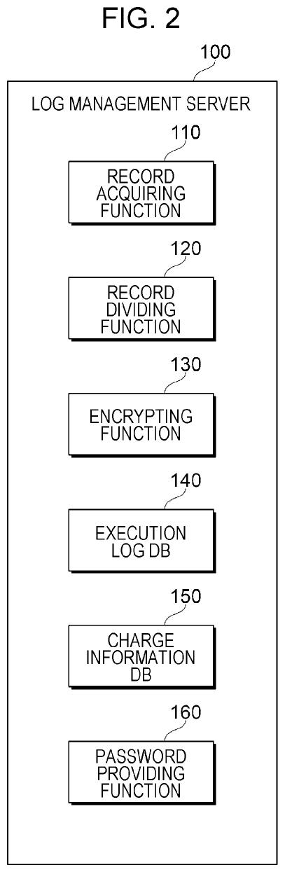

FIG. 2 illustrates the functional configuration of the log management server 100. The log management server 100 has a record acquiring function 110, a record dividing function 120, an encrypting function 130, an execution log database (DB) 140, a charge information database (DB) 150, and a password providing function 160.

The record acquiring function 110 is a function of acquiring a job log of the management target apparatus. The log management server 100 uses the record acquiring function 110 to acquire a job log from the image processing apparatus 200 that is the management target apparatus. The job log contains an execution log and charge information.

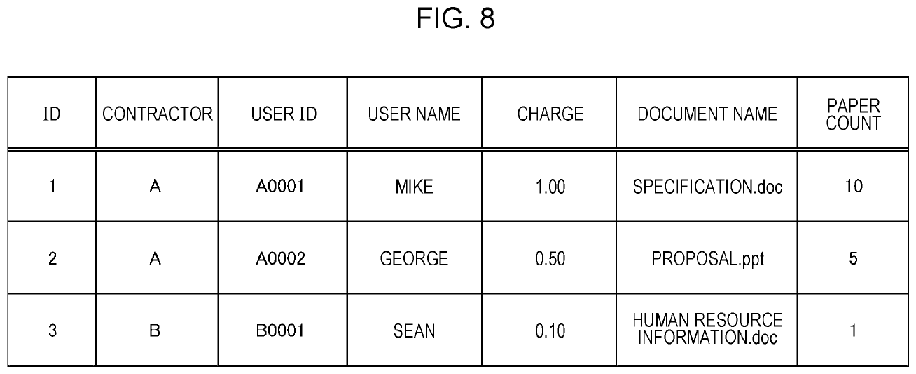

FIG. 8 illustrates an example of the structure of the job log. In the illustrated example, the job log is generated when a document is printed through a process (job) of the image processing apparatus 200. The job log illustrated in FIG. 8 contains records of “ID”, “contractor”, “user ID”, “user name”, “charge”, “document name”, and “paper count”. The item “ID” is identification information of a process executed by the image processing apparatus 200. The item “contractor” is identification information of a contractor related to the execution of the process. The contractor is an organization to which a user belongs (i.e., the contractor is an organization) or the user himself/herself (i.e., the contractor is the user himself/herself). The item “user ID” is identification information of the user who executed the process. For example, the user ID is input when the user logs in. The item “user name” is the name of the user who executed the process. The item “charge” is an amount of charging for the executed process. The item “document name” is the name of a document file subjected to the process. The item “paper count” is an amount of the executed process. In the illustrated example, the paper count is the number of output documents.

The record dividing function 120 is a function of dividing a job log into an execution log and charge information. In response to acquisition of a job log by the record acquiring function 110, the log management server 100 uses the record dividing function 120 to divide the acquired job log into an execution log and charge information.

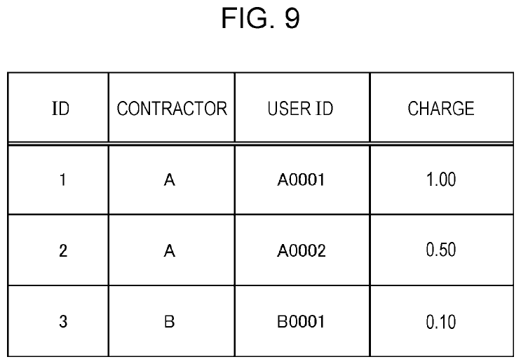

FIG. 9 illustrates an example of the structure of the charge information. The charge information illustrated in FIG. 9 is obtained by dividing the job log of FIG. 8. The charge information illustrated in FIG. 9 contains records of “ID”, “contractor”, “user ID”, and “charge”. Pieces of information in the individual items are similar to those described with reference to FIG. 8.

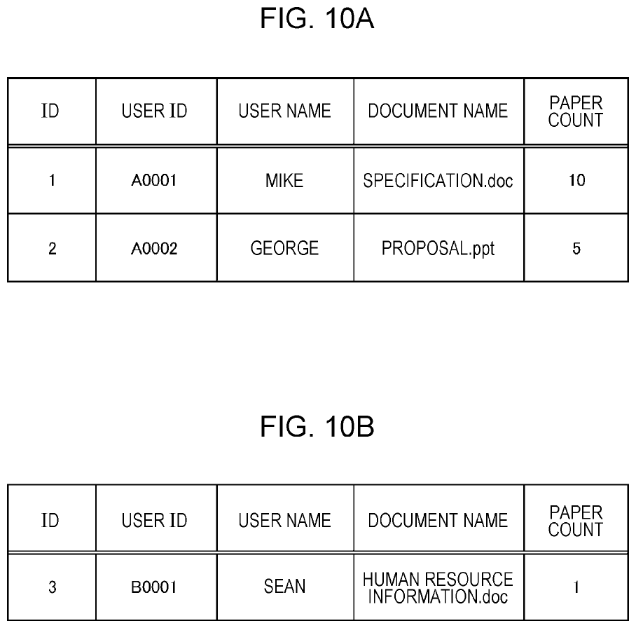

FIGS. 10A and 10B illustrate examples of the structures of execution logs. The execution logs are generated for the respective contractors. FIG. 10A illustrates an execution log of processes executed by users of a contractor A in FIG. 8. FIG. 10B illustrates an execution log of a process executed by a user of a contractor B in FIG. 8. The execution logs illustrated in FIGS. 10A and 10B are obtained by dividing the job log of FIG. 8. The execution logs illustrated in FIGS. 10A and 10B contains records of “ID”, “user ID”, “user name”, “document name”, and “paper count”. Pieces of information in the individual items are similar to those described with reference to FIG. 8.

The encrypting function 130 is a function of encrypting an execution log of the image processing apparatus 200 that is the management target apparatus. After a job log is divided by the record dividing function 120, the log management server 100 uses the encrypting function 130 to encrypt an obtained execution log. In the examples of the execution log illustrated in FIGS. 10A and 10B, information other than “IDs” for identifying processes in each log is encrypted. The encryption by the encrypting function 130 is performed by using an encryption key set for each contractor authorized to use the image processing apparatus 200 (hereinafter referred to as “set encryption key”).

The information recorded in the execution log may contain information acquired from a request to execute a process of the image processing apparatus 200. This information may be encrypted in the execution request at the time of issuing the execution request. For example, this situation may occur when the user uses his/her terminal apparatus to transmit a process execution request to the image processing apparatus 200 and the terminal apparatus has a function of encrypting bibliographic information to be attached to the execution request. At the time of encrypting the execution log by the encrypting function 130, the log management server 100 checks whether the information acquired from the execution request has been encrypted. If the information has been encrypted, the log management server 100 checks whether an encryption key used for the encryption is identical to the set encryption key of the contractor to which the user belongs.

If the information acquired from the execution request has been encrypted by the set encryption key, the log management server 100 does not further encrypt the encrypted information. If the information acquired from the execution request has been encrypted by an encryption key different from the set encryption key, the log management server 100 decrypts the encrypted information and encrypts the information by using the set encryption key. For example, a decryption key for decrypting the encrypted information may be acquired by sending a request to the user who has issued the execution request.

The execution log DB 140 manages execution logs. The execution log DB 140 stores execution logs generated along with execution of processes by the image processing apparatus 200. The execution logs are stored in association with contractors to which users who have issued process execution requests belong. The execution logs stored in the execution log DB 140 are encrypted by set encryption keys of the respective contractors. Each contractor has a decryption key (hereinafter referred to as “set decryption key”) for decrypting the execution log encrypted by the set encryption key of the contractor. Therefore, each contractor is allowed to decrypt and view their execution log but is forbidden to view execution logs of other contractors. The manager without the decryption key is also forbidden to view the execution log of each contractor.

The charge information DB 150 manages charge information. The charge information DB 150 stores charge information generated based on the use of the image processing apparatus 200. Only the manager has accessibility to the charge information DB 150 and is allowed to view the stored charge information. In this exemplary embodiment, the charge information stored in the charge information DB 150 is not encrypted. In view of security, however, the charge information may be encrypted and only the manager may decrypt the encrypted charge information.

The password providing function 160 is a function of providing a password to acquire a set decryption key. Each execution log stored in the execution log DB 140 is encrypted by a set encryption key, and a set decryption key corresponding to the set encryption key is needed to decrypt the encrypted execution log. In this exemplary embodiment, a password provided by the password providing function 160 is needed to acquire the set decryption key. The password has a valid period (i.e., the password is temporarily valid). After expiration of the valid period of the provided password, the password may no longer be used for acquiring the set decryption key.

The manager who needs to view an execution log requests a password from the log management server 100. In response to the manager's request for a password, the log management server 100 uses the password providing function 160 to provide a password. The execution log is encrypted by a set encryption key that is set for each contractor. Therefore, a set decryption key to be used for decrypting the execution log varies depending on contractors. The password to be provided by the password providing function 160 may be set to acquire only the set decryption key of the execution log of the contractor to be viewed by the manager.

In view of the fact that the manager may decrypt an execution log by acquiring a password, the manager may be required to obtain approval from a contractor related to the execution log to be viewed in order to provide the password. In this case, in response to the log management server 100 receiving the manager's request for the password, the log management server 100 inquires whether the contractor related to the execution log to be viewed by the manager approves the provision of the password. If approval is obtained from the contractor of interest, the log management server 100 provides the password to acquire a set decryption key corresponding to a set encryption key of the contractor.

<Hardware Configuration of Log Management Server>

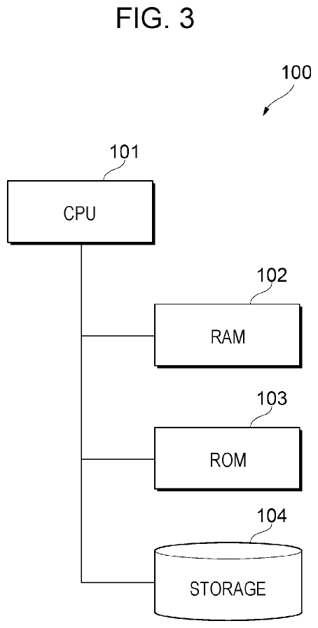

FIG. 3 illustrates an example of the hardware configuration of the log management server 100. The log management server 100 is implemented by a computer. The computer that implements the log management server 100 includes a central processing unit (CPU) 101 serving as a calculator and a random access memory (RAM) 102, a read only memory (ROM) 103, and a storage 104 each serving as a memory. The RAM 102 is a main memory to be used as a working memory when the CPU 101 performs arithmetic processes. The ROM 103 stores programs and data such as set values prepared in advance. The CPU 101 may execute processes by directly reading the programs and data from the ROM 103. The storage 104 stores programs and data. The CPU 101 executes the programs stored in the storage 104 by loading the programs on the RAM 102 that is the main memory. The storage 104 also stores results of the processes performed by the CPU 101. Examples of the storage 104 include a magnetic disk storage and a solid state drive (SSD).

In a case where the log management server 100 is implemented by the computer illustrated in FIG. 3, the record acquiring function 110, the record dividing function 120, the encrypting function 130, and the password providing function 160 illustrated in FIG. 2 are implemented by, for example, executing the programs by the CPU 101. The execution log database (DB) 140 and the charge information database (DB) 150 are implemented by, for example, the storage 104.

<Hardware Configuration of Image Processing Apparatus>

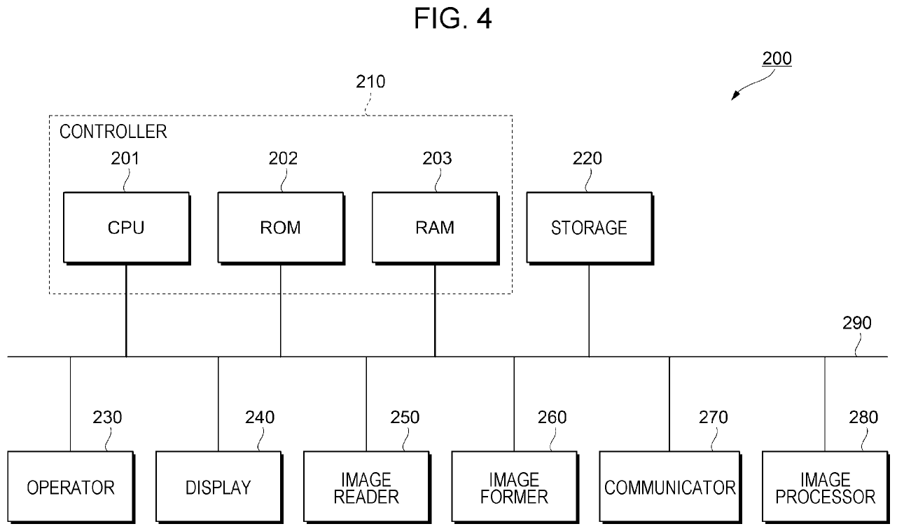

FIG. 4 illustrates an example of the hardware configuration of the image processing apparatus 200 that is an example of the management target apparatus. The image processing apparatus 200 includes a central processing unit (CPU) 201, a read only memory (ROM) 202, and a random access memory (RAM) 203 that constitute a controller 210. The image processing apparatus 200 further includes a storage 220, an operator 230, a display 240, an image reader 250, an image former 260, a communicator 270, and an image processor 280. Those components are connected to a bus 290 and exchange data via the bus 290.

The operator 230 receives users' operations. Examples of the operator 230 include a touch sensor that outputs a control signal based on a touch or push position of a finger. The touch sensor serving as the operator 230 and a liquid crystal display serving as the display 240 described later may be combined into a touch panel to implement a user interface.

The display 240 displays various screens. Examples of the display 240 include a liquid crystal display. Under control of the CPU 201, the display 240 displays various screens such as a screen showing information about conditions of the image processing apparatus 200, and a screen for setting functions of the image processing apparatus 200.

The image reader 250 is a so-called scanner, which optically reads an original image on a document set on the scanner and generates a read image (image data). Examples of the image reading system include a charge coupled device (CCD) system in which a light source radiates light onto a document, a lens condenses the light reflected from the document, and CCDs receive the condensed light, and a contact image sensor (CIS) system in which light emitting diodes (LEDs) serving as a light source sequentially radiate light beams onto a document and a CIS receives the light beams reflected from the document.

The image former 260 forms an image on paper that is an example of a recording material based on image data by using an image forming material. Examples of the system for forming an image on a recording material include an electrophotographic system in which an image is formed by transferring, onto a recording material, toner carried by a photoconductor, and an ink jet system in which an image is formed by ejecting ink onto a recording material.

The communicator 270 has a network interface for connection to the log management server 100 via the network. Examples of the network interface include a network adapter and a wireless communication module. In a case where the image processing apparatus 200 has a facsimile function, the communicator 270 has a communication module for facsimile communication. The communicator 270 may also have a module for LTE or 3G communication.

The image processor 280 includes a processor serving as a calculator and a working memory, and performs image processes such as color correction and gray level correction on an image shown by image data. The CPU 201 of the controller 210 may double as the processor, and the RAM 203 of the controller 210 may double as the working memory.

The storage 220 stores image data such as a read image generated by the image reader 250. Examples of the storage 220 include a magnetic disk storage and a non-volatile semiconductor memory.

The CPU 201, the ROM 202, and the RAM 203 constitute the controller 210. The ROM 202 stores programs to be executed by the CPU 201. The CPU 201 reads the programs stored in the ROM 202 and executes the programs by using the RAM 203 as a working area. Programs stored in the storage 220 may be loaded on the RAM 203 and the loaded programs may be executed by the CPU 201. By executing the programs by the CPU 201, the components of the image processing apparatus 200 are controlled and data processes are executed to implement functions described below.

In this exemplary embodiment, any user who wants to use the image processing apparatus 200 is required to log into a control system of the image processing apparatus 200 to identify the user for charging. In a case where the user operates the operator 230 to use the image processing apparatus 200, the user logs in via, for example, a login accepter provided in the image processing apparatus 200. Various existing methods may be used as a login method. Examples of the login method include a method in which the user operates the operator 230 to input login information such as a user ID and a password, and a method in which a reader (not illustrated) reads an ID card to accept login. In a case where the login information is input by the user's operation, the operator 230 operated by the user and the controller 210 that receives the operation on the operator 230 constitute the login accepter. In a case where the reader reads the ID card, the reader and the controller 210 that receives information read by the reader constitute the login accepter. In a case where a process execution request is transmitted from a user's terminal apparatus, the login information may be input, for example, when an application program for issuing the execution request is activated in the terminal apparatus.

<Functional Configuration of Controller>

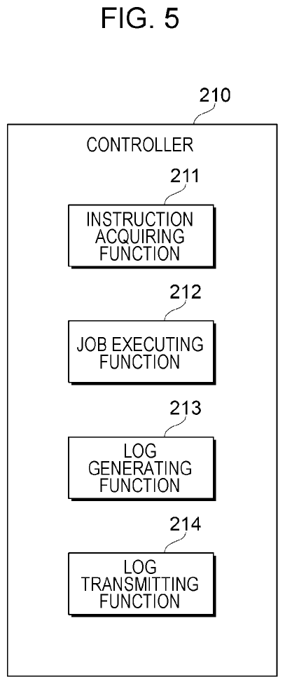

FIG. 5 illustrates the functional configuration of the controller 210 of the image processing apparatus 200. The controller 210 has an instruction acquiring function 211, a job executing function 212, a log generating function 213, and a log transmitting function 214.

The instruction acquiring function 211 is a function of acquiring a process execution instruction. The process execution instruction is acquired by a user's operation on the operator 230 or by receiving an execution request from a user's terminal apparatus via the communicator 270. In the information contained in the execution request issued by the user's terminal apparatus, a user name or bibliographic information such as a document name may be encrypted by an application program such as a driver installed in the terminal apparatus when the terminal apparatus transmits the execution request. The encryption may be performed by using a set encryption key of a contractor to which the user belongs.

The job executing function 212 is a function of executing a process (job) by the image reader 250 or the image former 260 in response to an execution instruction acquired by the instruction acquiring function 211. When the process is executed by the job executing function 212 in response to an execution instruction of an authenticated user, the execution of the process is charged.

The log generating function 213 is a function of generating, in response to execution of a process by the job executing function 212, record information (job log) based on the execution of the process. The job log contains not only information indicating details of the process executed by the image reader 250 or the image former 260, but also a user name or bibliographic information such as a document name acquired from an execution request issued by the user. The information acquired from the execution request may be encrypted. The job log also contains information on a charge for the execution of the process by the job executing function 212.

The log transmitting function 214 is a function of transmitting, to the log management server 100, a job log containing an execution log and charge information generated by the log generating function 213 after execution of a process by the job executing function 212 has been completed.

<Example of Operations of Log Management Server>

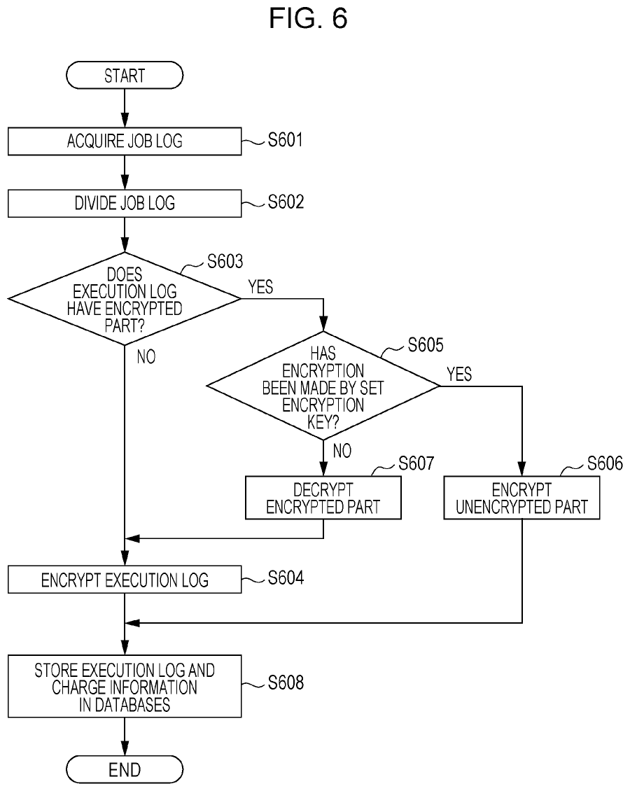

FIG. 6 is a flowchart illustrating operations to be performed when the log management server 100 acquires a job log. It is presupposed that the image processing apparatus 200 receives a process execution instruction, executes a process based on the received execution instruction, generates a job log along with the execution of the process, and transmits the generated job log to the log management server 100. The job log may contain information acquired from the execution instruction input to the image processing apparatus 200. This information may be encrypted.

The log management server 100 acquires the job log transmitted from the image processing apparatus 200 (S601), and divides the acquired job log into an execution log and charge information (S602). Next, the log management server 100 determines whether the execution log has an encrypted part. The part that may be encrypted is the information acquired from the process execution instruction for the image processing apparatus 200. If the execution log has no encrypted part (“NO” in S603), the log management server 100 encrypts the execution log by using a set encryption key of a contractor to which a user having issued the process execution instruction to the image processing apparatus 200 belongs (S604). The log management server 100 stores the encrypted execution log in the execution log DB 140 and the charge information in the charge information DB 150 (S608).

If the execution log has an encrypted part (“YES” in S603), the log management server 100 determines whether this part has been encrypted by using the set encryption key of the contractor to which the user having issued the process execution instruction to the image processing apparatus 200 belongs. The method for determining the encryption key is not particularly limited. For example, the determination may be made by acquiring an encryption key used for the encryption from a user's terminal apparatus. If the part has been encrypted by the set encryption key of the contractor of interest (“YES” in S605), the log management server 100 encrypts only an unencrypted part of the execution log (S606). The log management server 100 stores the encrypted execution log in the execution log DB 140 and the charge information in the charge information DB 150 (S608).

If the part of the execution log encrypted in advance has been encrypted by an encryption key other than the set encryption key of the contractor of interest (“NO” in S605), the log management server 100 decrypts the encrypted part (S607). The method for acquiring a decryption key for decrypting the encrypted part is not particularly limited. For example, a request may be transmitted to the user's terminal apparatus to acquire the decryption key. The log management server 100 then encrypts the entire execution log by the set encryption key of the contractor of interest (S604). The log management server 100 stores the encrypted execution log in the execution log DB 140 and the charge information in the charge information DB 150 (S608).

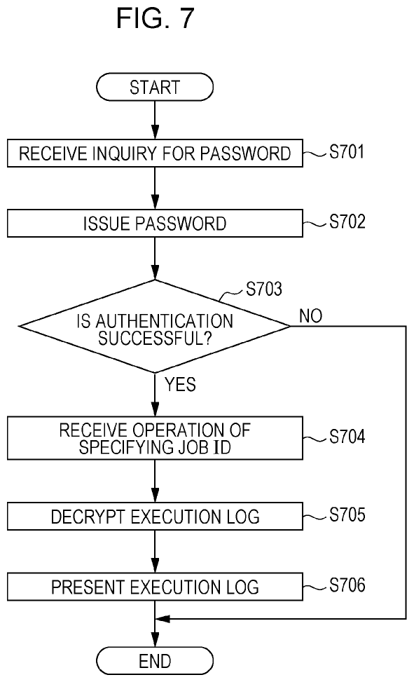

FIG. 7 is a flowchart illustrating operations to be performed by the log management server 100 when the manager refers to an execution log. In this operation example, the log management server 100 has a set decryption key and decrypts the execution log by the set decryption key in response to an access request from the manager.

The log management server 100 receives an inquiry for a password from a manager's terminal apparatus (S701), and issues a password (S702). In response to reception of a request to access the execution log together with the password from the manager's terminal apparatus, the log management server 100 executes an authentication process using the password. If the authentication is unsuccessful (“NO” in S703), the log management server 100 terminates the process because the request to access the execution log is invalid. Since the password has a valid period, the password whose valid period has expired results in an invalid access request even though the password was valid when issued by the log management server 100 in S702.

If the authentication using the password is successful (“YES” in S703), the log management server 100 receives an operation of specifying an ID of a process (job) to be accessed by the manager's terminal apparatus (“job ID” in FIG. 7) (S704). Next, the log management server 100 decrypts an execution log of the specified process (job) by using a corresponding set decryption key (S705). The log management server 100 presents the decrypted execution log in response to the access request from the manager's terminal apparatus (S706).

In the exemplary embodiment described above, the log management server 100 has a set decryption key and decrypts an execution log in response to an access request from the manager. The set decryption keys may be managed by an external server and a necessary set decryption key may be acquired by using a password. Further, the manager may acquire a set decryption key by using a password issued by the log management server 100, also acquire an encrypted execution log, and decrypt the execution log by the set decryption key on the manager's terminal apparatus.

In response to expiration of a valid period of a password issued by the log management server 100, an execution log decrypted by a set decryption key acquired by using the password may be encrypted by another set encryption key different from a previous set encryption key.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A record management apparatus comprising a processor configured to
about use of an apparatus by an authorized user other than a manager of the apparatus, acquire an execution record of a process performed by the apparatus and charge information about a charge for the process,
encrypt the execution record by using a specific encryption key,
store the charge information and the encrypted execution record in a storage, and
in response to a request from the manager, provide to the manager a password that is temporarily valid to acquire a decryption key for decryption of the encrypted execution record.

2. The record management apparatus according to claim 1, wherein the encryption key and the decryption key are set for each entity authorized to use the apparatus.

3. The record management apparatus according to claim 2, wherein the processor is configured to, when providing the password to the manager, obtain approval from the entity related to the execution record to be viewed by the manager.

4. The record management apparatus according to claim 1, wherein the processor is configured to
if specific information acquired from a process execution request for the apparatus has been encrypted by using the specific encryption key in the process execution request,
record the specific information in the execution record without further encrypting the specific information, and
store the execution record in the storage.

5. The record management apparatus according to claim 4, wherein the processor is configured to
if the specific information has been encrypted by using another encryption key different from the specific encryption key in the process execution request,
decrypt the specific information,
encrypt the specific information by using the specific encryption key,
record the specific information in the execution record, and
store the execution record in the storage.

6. A record management apparatus comprising:
means for, about use of an apparatus by an authorized user other than a manager of the apparatus, acquiring an execution record of a process performed by the apparatus and charge information about a charge for the process;
means for encrypting the execution record by using a specific encryption key;
means for storing the charge information and the encrypted execution record in a storage; and
means for, in response to a request from the manager, providing to the manager a password that is temporarily valid to acquire a decryption key for decryption of the encrypted execution record.
